(19) United States
(12) Patent Application Publication
(10) Pub. No.: US 2025/0121682 A1
(43) Pub. Date: Apr. 17, 2025

(54) SERIES MOUNTED AXIAL COUPLING

(71) Applicant: WARN Automotive, LLC, Milwaukie, OR (US)

(72) Inventors: Adam Reiner, Wilsonville, OR (US); Joshua Taylor Roat, Portland, OR (US)

(21) Appl. No.: 18/915,888

(22) Filed: Oct. 15, 2024

Related U.S. Application Data
(60) Provisional application No. 63/590,618, filed on Oct. 16, 2023.

(51) Int. Cl. B60K 17/35

(52) U.S. Cl. CPC B60K 17/3515

(57) ABSTRACT

The present disclosure describes an axial coupling and methods of assembly. The assembly method can include installing an axle into a disconnect, the disconnect having a disengaged state permitting relative motion between the axle and a hub, and an engaged state preventing relative rotation between the axle and the hub. The disconnect can be mounted on a knuckle that includes a wheel-facing side and a vehicle-facing side. The disconnect can be mounted on the wheel facing side of the knuckle. The hub can be mounted to the disconnect.

### CLAIM OF PRIORITY

This application claims priority under 35 USC § 119 (e) to U.S. Patent Application Ser. No. 63/590,618, filed on Oct. 16, 2023, the entire contents of which is hereby incorporated by reference.

### TECHNICAL FIELD

This disclosure generally relates to wheel hubs that are actuatable to couple and decouple the wheel hubs from a drive axle.

### BACKGROUND

Some vehicles employ four-wheel drive systems to increase traction for off-road driving as well as low traction for on-road driving to improve efficiency. However, it may be desirable to provide optional engagement/disengagement of the four-wheel drive system to increase the versatility of the vehicle. Specifically, two of the drive wheels may be disengaged to provide two-wheel drive during on-road driving to increase the vehicle's fuel and/or battery economy. On the other hand, four-wheel drive may be used to provide increased traction during certain driving conditions, such as vehicle operation on dirt roads, snow, etc. In this way, a user may adjust a vehicle's drivetrain based on the driving circumstances and the desired vehicle performance characteristics.

Engagement of four-wheel drive systems may be automatically activated or manually activated. Although automatic four-wheel drive engagement has a number of benefits, such as decreased user interaction, automatic four-wheel drive engagement systems also may have some drawbacks, such as greater manufacturing costs as well as repair and maintenance costs. On the other hand, manually engaged four-wheel drive systems have certain benefits over automatically engaged systems, such as increased reliability and decreased manufacturing and repair costs. Therefore, manual four-wheel drive systems may be desired by users who prefer less complex and more reliable four-wheel drive systems, such as off-road enthusiasts.

### SUMMARY

In general, the disclosure involves an axial coupling and methods of assembly. The assembly method can include installing an axle into a disconnect, the disconnect having a disengaged state permitting relative motion between the axle and a hub, and an engaged state preventing relative rotation between the axle and the hub. The disconnect can be mounted on a knuckle that includes a wheel-facing side and a vehicle-facing side. The disconnect can be mounted on the wheel facing side of the knuckle. The hub can be mounted to the disconnect.

Implementations can optionally include one or more of the following features.

In some instances, the hub is supported by a bearing assembly. In some implementations, the disconnect is mounted to the knuckle and the bearing assembly is mounted to the disconnect using the same mounting points. In some instances, fasteners are installed in the mounting points that extend through a face of the bearing assembly, through a housing of the disconnect, and into the wheel-facing side of the knuckle.

In some instances, the knuckle is installed on a vehicle before the disconnect is mounted on the knuckle.

In some instances, the disconnect includes an inner drive gear and a clutch ring. The inner drive gear is configured to translate axially to shift the disconnect between the engaged state and the disengaged state. In some instances, the inner drive gear is engaged to a plurality of splines on the axle, and the clutch ring is engaged to a plurality of splines on the hub.

In some instances, the disconnect includes a thrust bearing or thrust washer positioned to reduce wear between the hub and the disconnect.

In some instances, a motor assembly is installed into the disconnect. In some instances, the motor assembly includes snap-fit connectors.

In some instances, mounting the disconnect on the knuckle includes aligning a perimeter of a vehicle-facing surface of the disconnect with a perimeter of the wheel-facing side of the knuckle.

Implementations can include one or more of the following advantages. The ability to disconnect driveline components from wheel-end components allows for enhanced fuel efficiency by minimizing parasitic loads of rotating components when no torque transfer is necessary. The disclosed disconnect enables simpler assembly and installation, allowing for more reliable machinery requiring less labor to manufacture. Further, serially mounting the disconnect as discussed enables additional outboard bearings, which improve wheel-end and vehicle durability.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

In general, this disclosure relates to wheel hub disconnects

FIG. 1 is a perspective view of a wheel end including a series mounted axial coupling.

FIG. 2 is an exploded perspective view of a wheel end including a series mounted axial coupling.

FIG. 3 is a side, exploded view of a wheel end including a series mounted axial coupling.

FIG. 4 is a perspective view of a knuckle and disconnect with shared mounting points.

FIG. 5A is side cross-sectional view of an axial coupling.

FIG. 5B is a perspective exploded view of certain components of an axial coupling.

FIG. 6A is a simplified schematic showing an axial coupling in an engaged position.

FIG. 6B is a simplified schematic showing an axial coupling in a disengaged position.

FIG. 7 is a side cross-sectional view of an alternative axial coupling.

FIG. 8 is a flowchart illustrating an example assembly process for a wheel end including a series mounted axial coupling.

FIGS. 9A-9E illustrate an example assembly process for a wheel end including a series mounted axial coupling.

### DETAILED DESCRIPTION

This disclosure describes a serially mounted axial coupling and method for assembling a wheel end with a serial mounted axial coupling. Axial couplings, or disconnects, are be used in vehicles to permit rotation of a wheel or wheel-end without requiring rotation of the entirety of the driveline components of the car, reducing parasitic energy losses when the driveline is not supplying power to the wheel. Wheel-ends are often complex sets of components that are manufactured using complex multi-step processes.

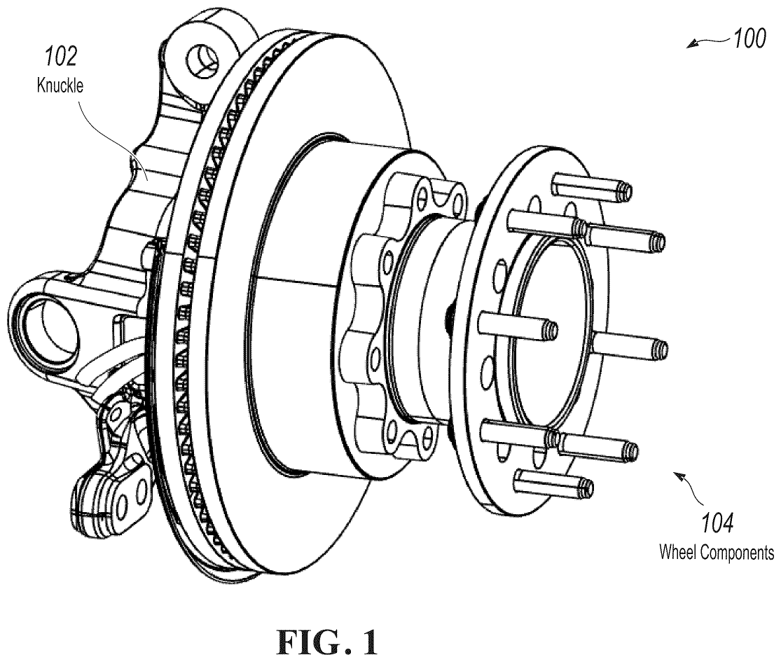

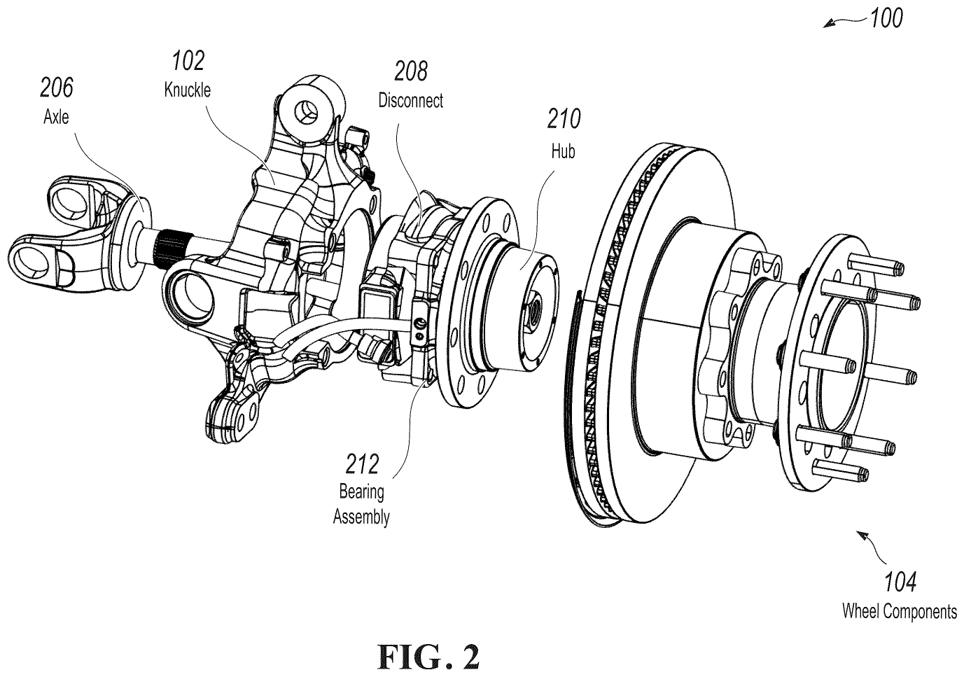

FIG. 1 is a perspective view of a wheel end 100 including a series mounted axial coupling. As seen in figure one, a knuckle 102 is used as a main structure onto which other components of the wheel end 100 are mounted. The wheel components 104 can include lugs, a brake rotor, bearings etc. and are generally mounted to the wheel hub (illustrated below in FIG. 2) in order to provide a mounting structure for mounting a wheel.

Knuckle 102 is a structural component. Knuckle 102 is coupled to the vehicle suspension in order to allow for travel, e.g., movement of the wheel end 100 relative to a vehicle's frame. Connecting rods also may be coupled to knuckle 102 to provide for steering. As illustrated, the knuckle has a wheel facing side, onto which wheel components 104 are mounted, and a vehicle facing side used for mounting the knuckle 102 to the vehicle.

FIG. 2 is an exploded perspective view of a wheel end 100 including a series mounted axial coupling. FIG. 2 illustrates the knuckle 102 in relation to the wheel components 104. Wheel end 100 includes axle 206, disconnect 208, hub 210, and bearing assembly 212 which are nested together in series, when assembled, within the wheel components 104.

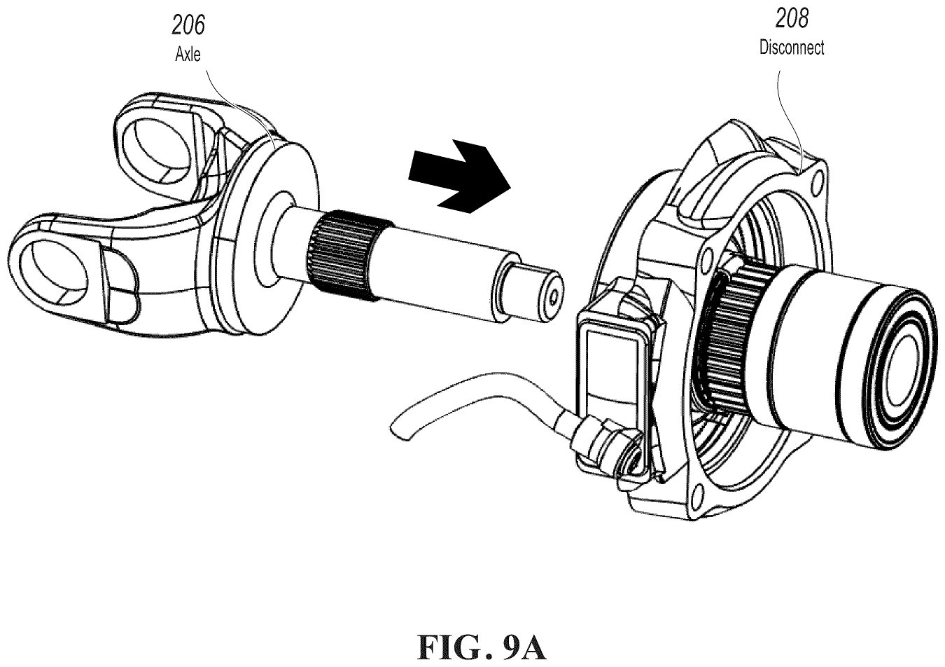

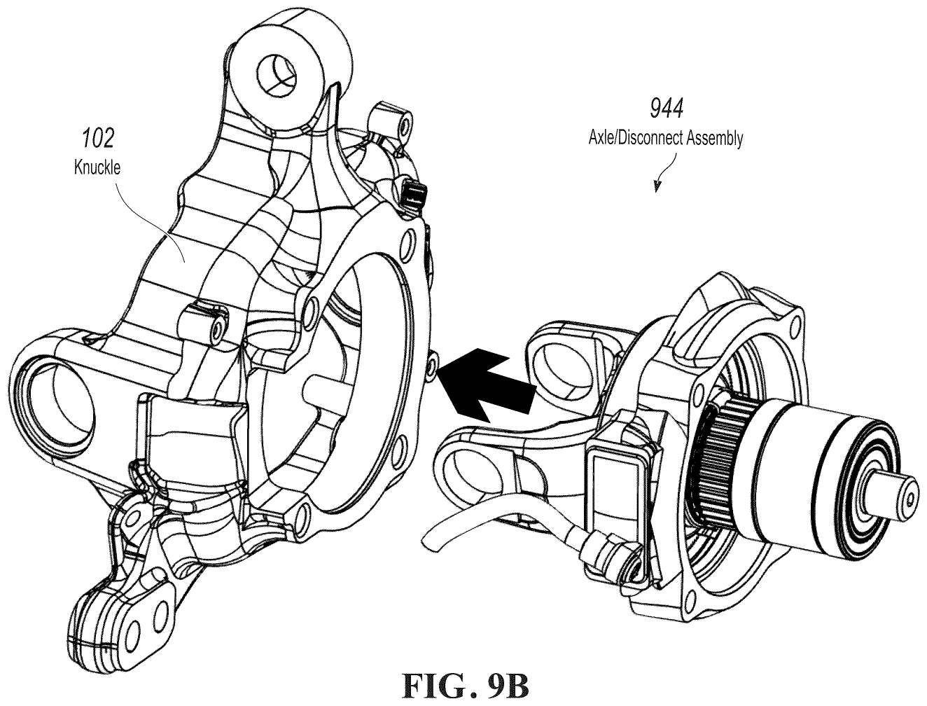

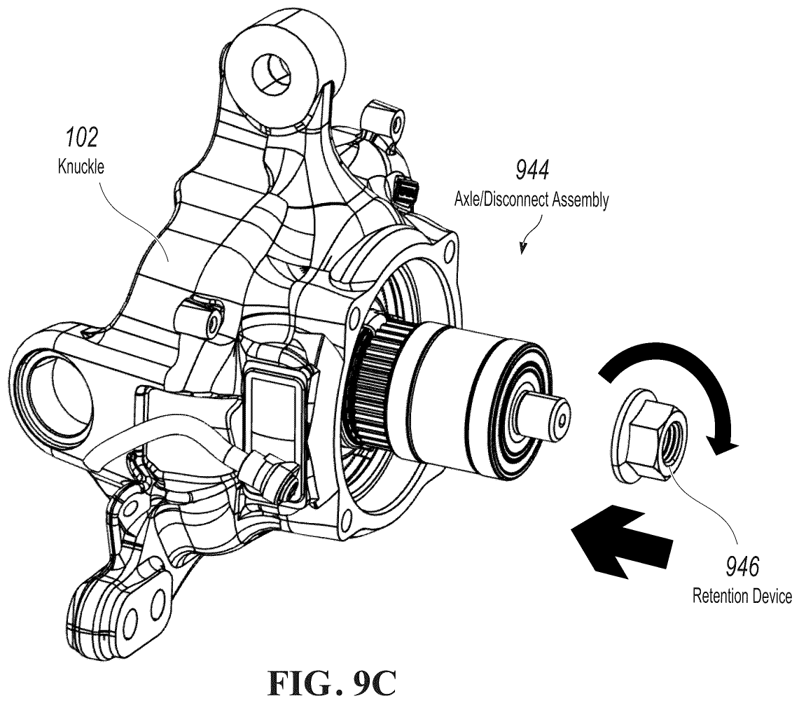

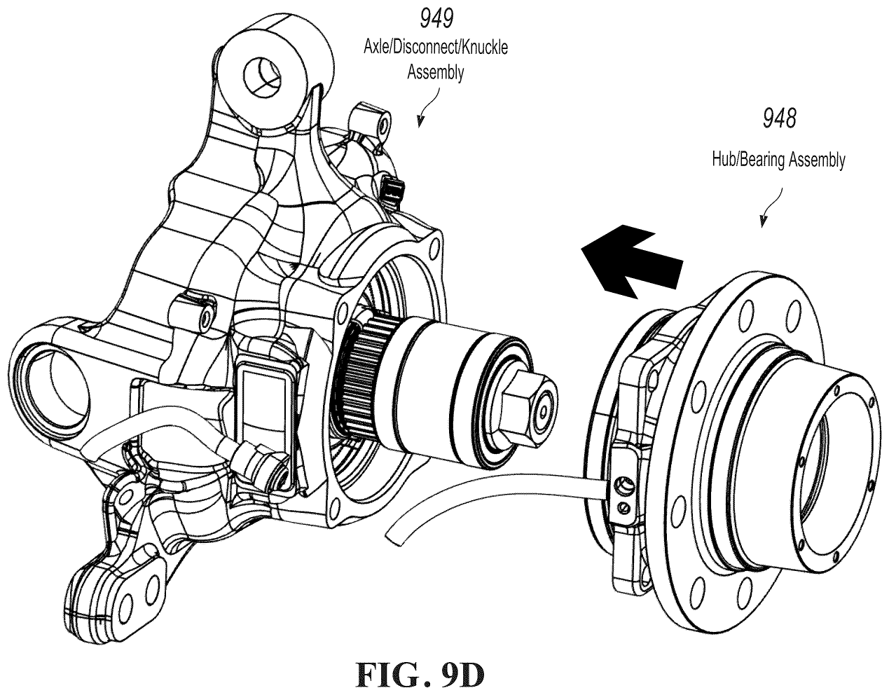

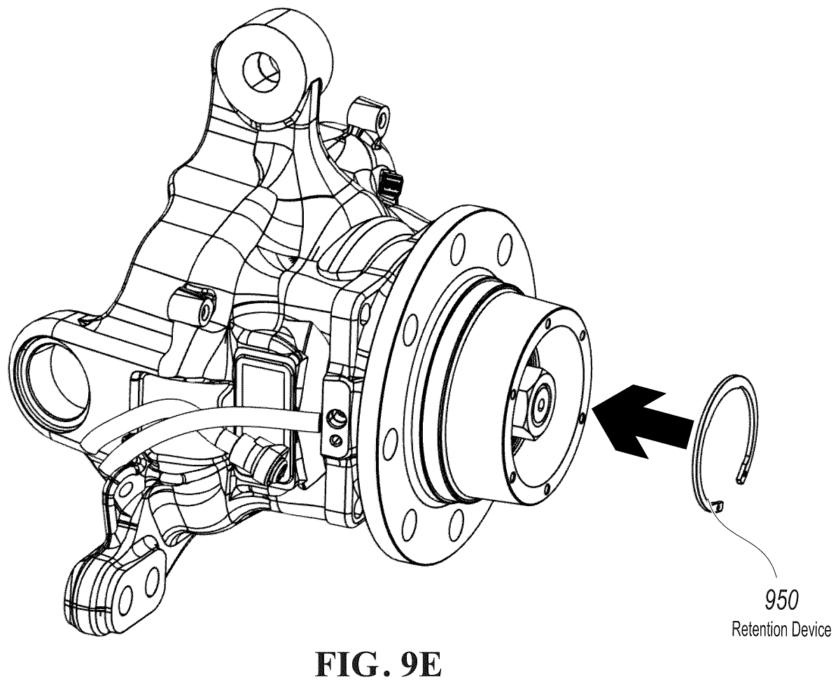

Axle 206 delivers torque from drive components of the vehicle (e.g., an electric motor, or internal combustion engine), through disconnect 208 and to hub 210 when disconnect 208 is in an engaged configuration. When disconnect 208 is in a disengaged configuration, axle 206 and hub 210 rotate independently. Axle 206 includes a splined end for delivering torque, and a forked end. The forked end, when fully assembled, forms a portion of a universal joint, allowing axle 206 to be driven by an off-axis shaft (not shown). In the illustrated embodiment, axle 206 can fit entirely through a center hole within knuckle 102, enabling axle 206 to be installed within the disconnect 208 prior to being mounted on knuckle 102. This is described in more detail below with respect to FIGS. 8 and 9A-E.

A bearing assembly 212 provides structural support for hub 210 while allowing hub 210 to rotate relative to disconnect 208. Bearing assembly 212 can include a number of bearings, as well as seals and sensors such as an anti-lock brake sensor or wheel speed sensor.

Hub 210 provides a mounting surface for wheel components 104. Hub 210 interfaces with disconnect 208 and is supported by bearing assembly 212.

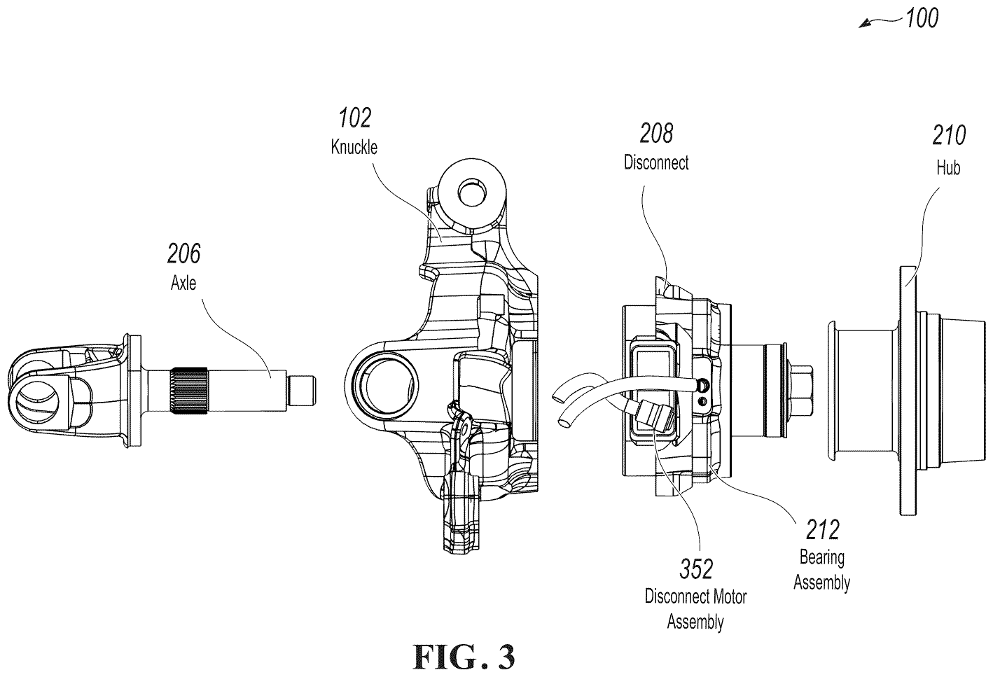

FIG. 3 is a side, exploded view of a wheel end 100 including a series mounted axial coupling. FIG. 3 illustrates how knuckle 102, disconnect 208, and bearing assembly are mounted together serially. That is, when assembled, the disconnect 208 is sandwiched between the knuckle 102 and the bearing assembly 212 or hub 210.

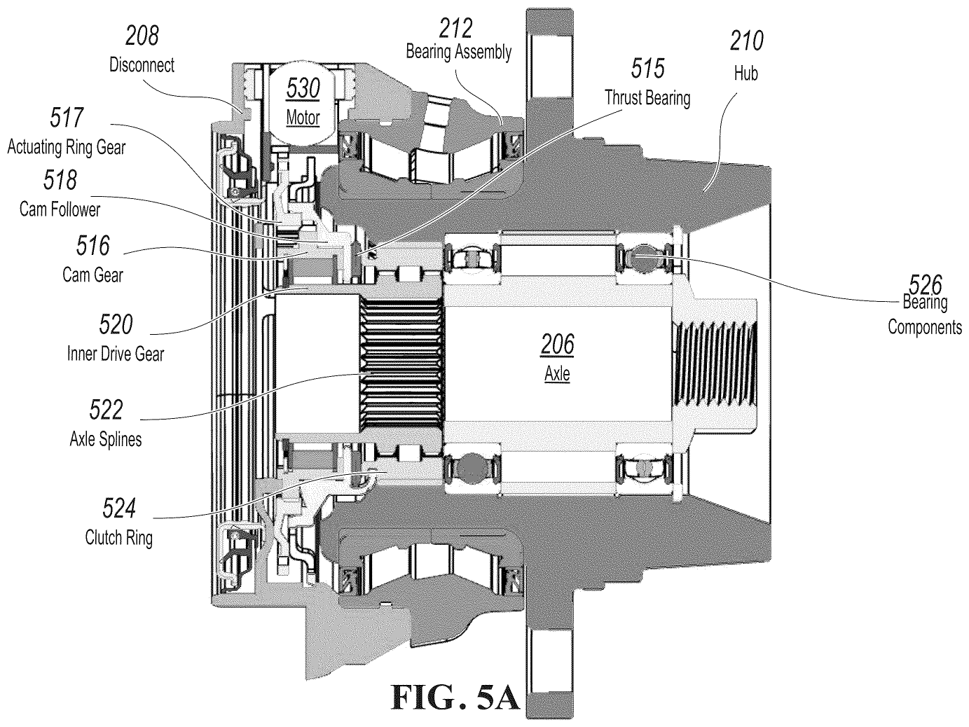

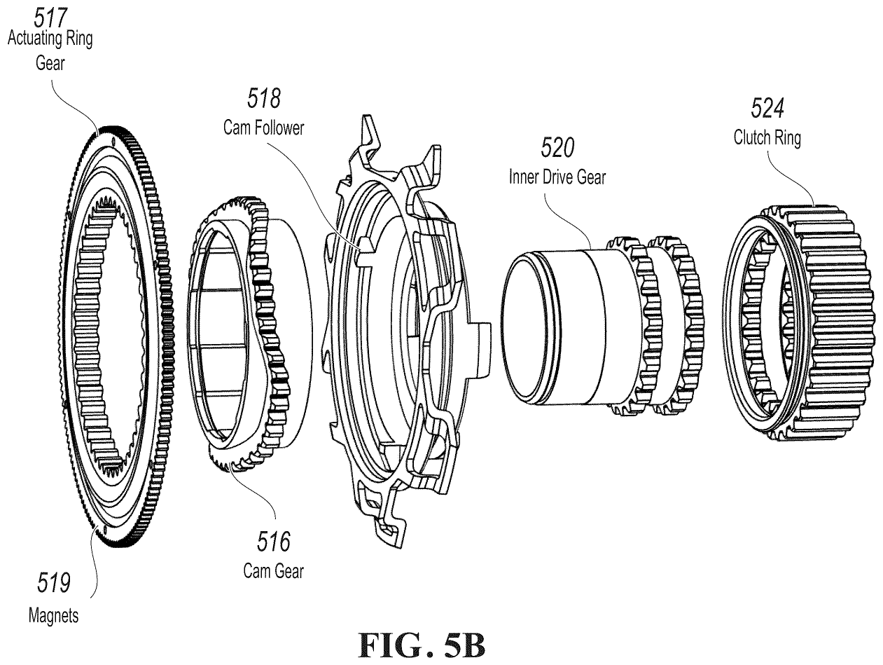

A disconnect motor assembly 352 is illustrated which actuates disconnect 208. That is, disconnect motor assembly 352 provides the motive force to switch disconnect 208 from an engage state to a disengaged state, and from the disengaged state to the engaged state. In some implementations, disconnect motor assembly 352 includes an electric motor mounted on a bracket and configured to “snap” into place in disconnect 208, thereby removing the need for separate fasteners. For example, the motor assembly 352 is configured with as snap-fit connector that mates with a corresponding snap-fit connections within the disconnect 208. In some implementations, disconnect motor assembly 352 may use one or more of a vacuum, spring, pneumatic system, valve mechanism, solenoid, or other electromagnetic actuator that is known to one of ordinary skill in the art to actuate disconnect 208. In some implementations, disconnect motor assembly 352 uses one or more solenoids to actuate disconnect 208. In the illustrated implementation, an electric motor is mounted within a case, the electric motor drives a worm gear which rotates a spur gear that is engaged with a ring gear (illustrated in more detail below with respect to FIGS. 5A and 5B) to actuate disconnect 208.

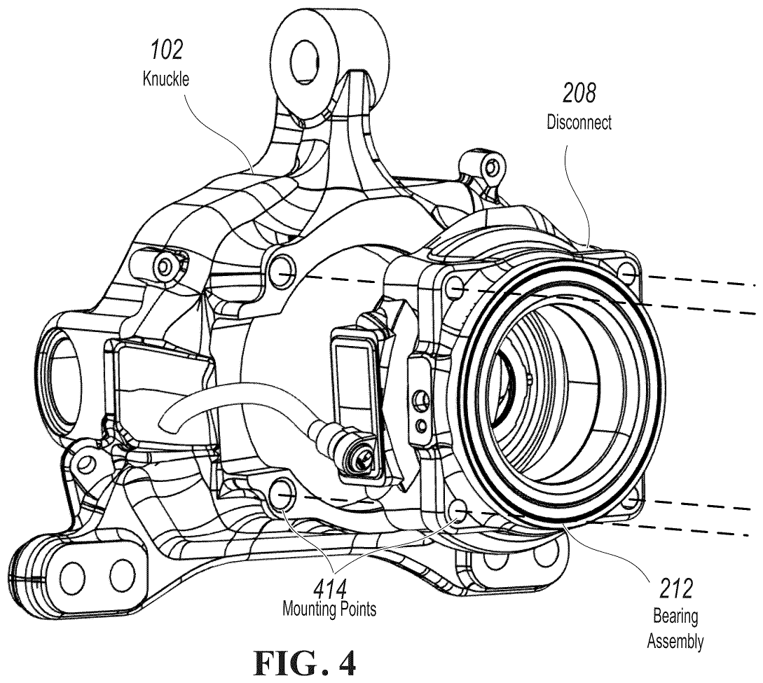

FIG. 4 is a perspective view of a knuckle and disconnect with shared mounting points. Mounting points 414 can be shared between knuckle 102, disconnect 208, and bearing assembly 212, allowing for ease of installation and reduction of total parts. In some implementations, the disconnect 208 and bearing assembly 212 are bolted onto the knuckle 102. In some implementations they are screwed into mounting points. Any suitable fastener is considered within the scope of this disclosure which may include any combination of one or more screws, bolts, snap fittings, rivets, studs, or anchors.

FIG. 5A is a side cross-sectional view of an axial coupling. FIG. 5A illustrates many of the moving components associated with actuating (e.g., engaging or disengaging) disconnect 208. Axle 206 supports hub 210 via bearing components 526, which transfer loads between hub 210 and axle 206, while allowing hub 210 to rotate about axle 206 when disconnect 208 is disengaged. FIG. 5A shows disconnect 208 in an engaged position, thus axle 206 is rotationally locked to hub 210 and torque transfer between axle 206 and hub 210 is possible.

Axle 206 includes axle splines 522 which mechanically index inner drive gear 520 to axle 206 such that inner drive gear 520 rotates with axle 206. Inner drive gear 520 is free to slide axially (in a left-right direction in FIG. 5A) along axle 206. When in an engaged position (to the right as shown in FIG. 5A) inner drive gear 520 meshes with clutch ring 524. Clutch ring 524 is in turn meshed with hub 210 such that when disconnect 208 is in the engaged position as shown, torque is transmitted through axle 206, inner drive gear 520, clutch ring 524, hub 210 to wheel components (e.g., wheel components 104 of FIG. 1).

In order to translate the inner drive gear 520, motor 530 rotates an actuating ring gear 517, which rotates a cam gear 516. Cam gear 516 can be spring biased in a particular direction (e.g., to the right) and as it rotates, it is translated axially by cam follower 518. Cam gear 516 can be coupled to inner drive gear 520 in a manner that permits independent rotation, but coupled translation. That is, when cam gear 516 translates axially (e.g., left and right), then inner drive gear 520 also is translated axially. In some implementations, a manual override function is provided to manually connect/disconnect the inner drive gear 520. This enables manual switching of the vehicle from, for example, 4WD to 2WD in order to be towed in the event of a complete power failure. The manual override can be a set of pints or other mechanical features that can press onto the inner drive gear 520 when actuated through a mechanical device (e.g., a keyed dial nut) on the outside of the hub 210.

In some implementations, a thrust bearing 515 is provided to reduce or prevent wear between the clutch ring 524, which rotates at the same rate as the hub 210 (and thus the vehicle wheel) and certain disconnect components (such as the cam follower 528 as illustrated in FIG. 5A) which are stationary relative to the vehicle wheel end. Thrust bearing 515 can be particularly effective at preventing transient wear events during engaging and disengagement of inner drive gear 520 from clutch ring 524. In addition to preventing transient wear events, thrust bearing 515 reduces “spin loss” or losses resulting in energy consumption during vehicle movement. Alternatively, a thrust washer can be used instead of the thrust bearing 515. The thrust washer can perform a similar function and yield similar advantages as thrust bearing 515.

FIG. 5B is a perspective exploded view of certain components of an axial coupling. FIG. 5B illustrates actuating gear ring 517, which is rotated in order to cause cam gear 516 to rotate and translate axially. Cam follower 518 can be rigidly mounted to, for example, the case of the disconnect, such that it does not rotate or translate relative to the system. Notches or protrusions in cam follower 518 can force cam gear 516 to translate axially as cam gear 516 rotates. Cam gear 516 includes a cam and teeth that mesh with actuating ring gear 517. In the illustrated implementations, the teeth of cam gear 516 also act as a cam. In some implementations cam gear 516 includes separate teeth and cam components.

Cam gear 516 is coupled to inner drive gear 520, such that inner drive gear 520 can rotate independently of cam gear 516, but translates axially with cam gear 516. Inner drive gear 520 is configured to mesh with clutch ring 524 in order to engage or disengage. Inner drive gear 520 is splined to the axle 206, while clutch ring 524 is splined to hub 210. When inner drive gear 520 and clutch ring 524 are meshed, the disconnect can be said to be engaged.

In some implementations, magnets 519 are disposed around the periphery of actuating ring gear 517. These magnets 519 can be used for position indication, rotational speed indication, and/or angular momentum of the actuating ring gear 517 and can enable an inference of whether the disconnect 208 is in an engaged or disengaged state. Magnets 519 can be permanent magnets (e.g., neodymium, ceramic, or ferrite magnets) or electro-magnets.

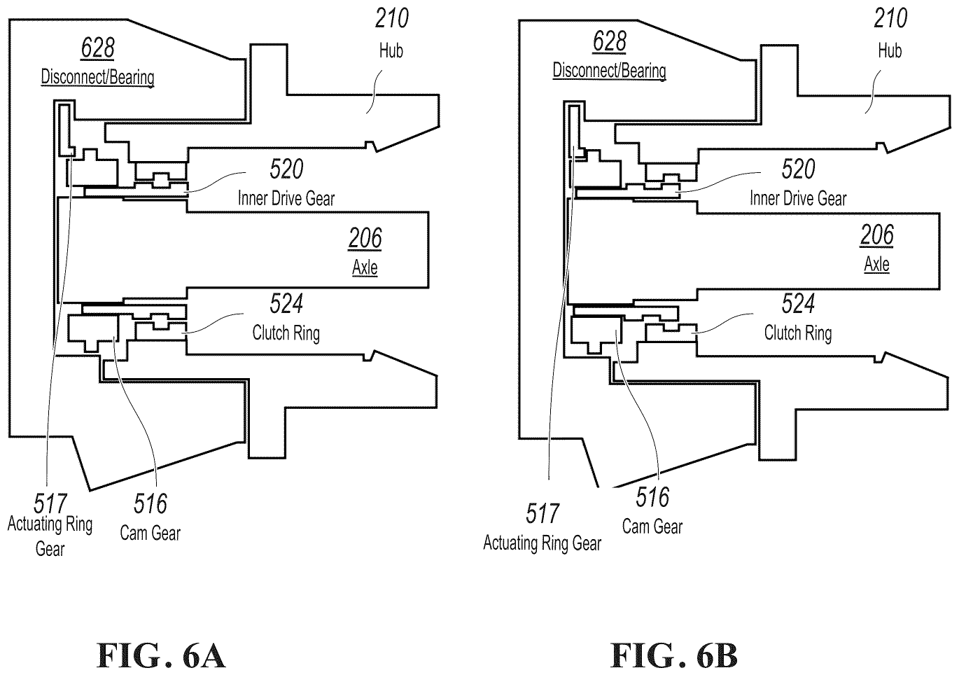

FIG. 6A is a simplified schematic showing an axial coupling in an engaged position. Inner drive gear 520 has been shifted axially (e.g., to the right) and meshes with clutch ring 524.

FIG. 6B is a simplified schematic showing an axial coupling in a disengaged position. Inner drive gear 520 has been shifted axially (e.g., to the left) and no longer meshes with clutch ring 524, allowing independent rotation of the axle 206 and hub 210. It should be noted that in some implementations, a third state is possible. For example, in an intermediate position, or a third position, the inner drive gear 520 can engage the axle 206 with the knuckle (e.g. knuckle 102 of FIG. 1) or other fixed structural component, in order to provide a “locked” or “parking brake” state that prevents movement of the wheel components.

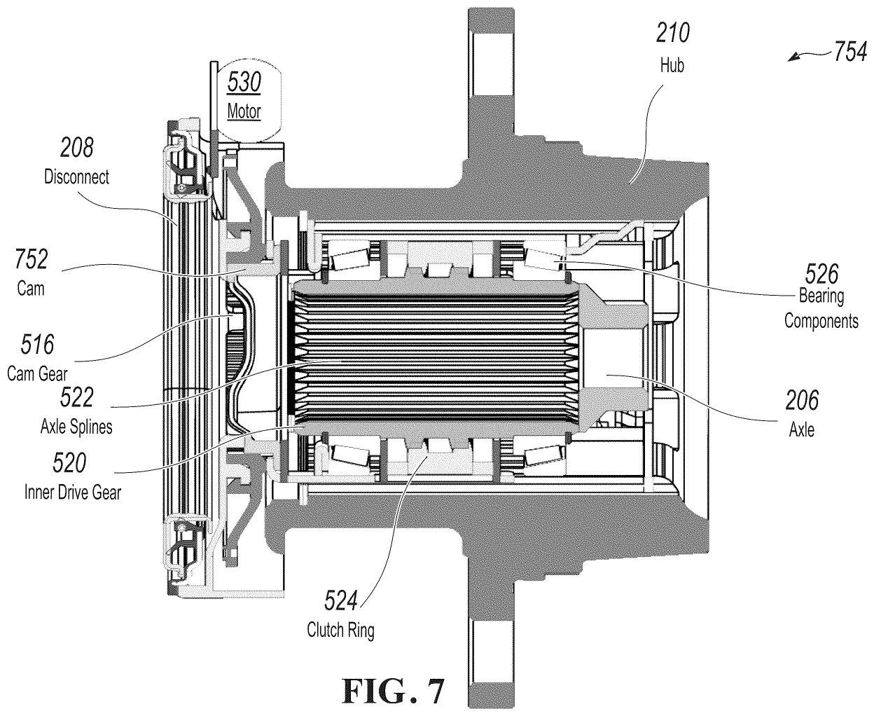

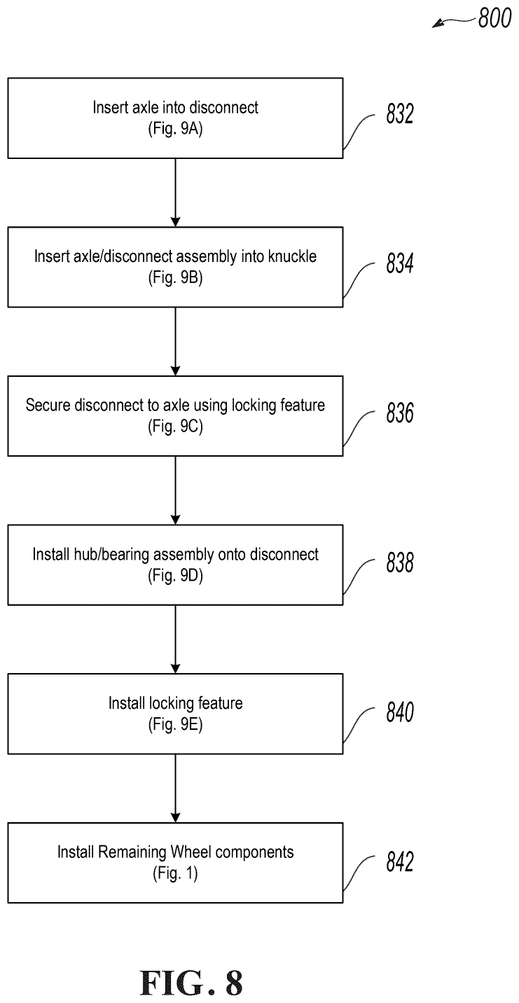

FIG. 7 is a side cross-sectional view of an alternative axial coupling 754. Axial coupling 754 illustrates a different implementation, where inner drive gear 520 and clutch ring 524 interact in a more central location along the axle 206. In the illustrated embodiment, bearing components 526 are positioned on both sides of the inner drive gear 520 and the clutch ring 524. In this manner, the bearing components 526 can be integrated into the hub 210 which provides a more robust and simplified construction. Additionally, cam gear 517 rotates and translates along a cam 752, in order to move clutch ring 524 in and out of engagement with inner drive gear 520. It should be noted that axial coupling 754 is presented as an example, and additional configuration of axial couplings are possible and considered within the scope of the present disclosure.

FIG. 8 is a flowchart illustrating an example assembly process 800 for a wheel end including a series mounted axial coupling. In some implementations, not each element of process 800 is required, further, some elements can be performed in parallel, or in different orders. For example, 834 can be performed after, or in parallel with 836. In some implementations process 800 or portions thereof are performed automatically, for example, by a robotic assembly system. While process 800 is described in terms of the foregoing figures and descriptions (e.g., FIGS. 1-7) it will be understood that process 800 can be applied to any suitable axial coupling.

At 832, an axle is inserted into a disconnect. This is illustrated in example FIG. 9A below. During installation, the axle is aligned with splines of an inner drive gear (e.g., inner drive gear 520 of FIGS. 5A and 5B). It should be noted that, while illustrated with hub engaging splines on only a portion of the disconnect 208, in some implementations the hub engaging splines can travel most of the length of the disconnect 208 to engage with the hub (e.g., hub 210 of FIG. 2).

At 834, the axle/disconnect assembly (e.g., axle/disconnect assembly 944 of FIG. 9B below) is inserted into a vehicle knuckle. This is illustrated in example FIG. 9B below. The vehicle knuckle can be, for example, knuckle 102 of FIG. 1, and can include a central cavity that is sufficient in size to permit the axle to pass through/into the knuckle while allowing the disconnect to mount to a face on front of the knuckle. In some implementations, the disconnect can be mounted to the knuckle first, and the axle inserted into the disconnect through the rear of the knuckle. These implementations can be particularly useful where the axle does not fit through the knuckle.

At 836, the disconnect and the axle are secured using a locking feature. An example is illustrated below in FIG. 9C, where retention device 946 is threaded onto the axle/disconnect assembly 944. In some implementations, and as shown in the illustrated example, the retention device 946 is a nut or threaded fastener. In some implementations, retention device 946 can be a locking ring, a spring, adhesive, cotter pin, or other mechanism. In some implementations, retention device 946 can be installed prior to axle disconnect assembly 944 being mounted on knuckle 102.

At 838, a hub/bearing assembly is installed onto the disconnect as illustrated in an example in FIG. 9D. In some implementations the hub/bearing assembly 948 is assembled remotely and is configured to form a seal when mounted onto the axle/disconnect/knuckle assembly 949. In some implementations the hub is installed first on the disconnect, then the bearing assembly is installed once the hub is in place. Additionally, in some implementations, 838 occurs prior to 834 and 836, based on the particular assembly requirements of a given manufacturing process.

At 840, a locking feature is installed to ensure retention between the hub bearing assembly 948 (or hub) and the disconnect. As illustrated in example FIG. 9E, retention device 950 can be a locking ring, which is compressed and installed in a groove within an inner slot of the hub.

With the disconnect, bearing assembly, and hub in place over the axle on the knuckle, one or more bolts can be threaded through the assembly, and torqued to provide a rigid single structure that forms a knuckle-disconnect-bearing/hub serial layout.

At 842, remaining wheel end components such as lugs, brake rotor, or other components can be installed on the hub.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can, in some cases, be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The foregoing description is provided in the context of one or more particular implementations. Various modifications, alterations, and permutations of the disclosed implementations can be made without departing from scope of the disclosure. Thus, the present disclosure is not intended to be limited only to the described or illustrated implementations, but is to be accorded the widest scope consistent with the principles and features disclosed herein.

1. A vehicle wheel end assembly method comprising:
installing an axle into a disconnect, the disconnect comprising a disengaged state permitting relative rotation between the axle and a hub, and an engaged state preventing relative rotation between the axle and the hub;
mounting the disconnect on a knuckle comprising a wheel-facing side and a vehicle-facing side, wherein the disconnected is mounted on the wheel facing side of the knuckle; and
mounting a hub to the disconnect.

2. The method of claim 1, wherein the hub is supported by a bearing assembly.

3. The method of claim 2, wherein the disconnect is mounted to the knuckle and the bearing assembly is mounted to the disconnect using the same mounting points.

4. The method of claim 3, further comprising installing fasteners in the mounting points, wherein the fasteners extend through a face of the bearing assembly, through a housing of the disconnect, and into the wheel-facing side of the knuckle.

5. The method of claim 1, comprising installing the knuckle on a vehicle before mounting the disconnect on the knuckle.

6. The method of claim 1, wherein the disconnect comprises an inner drive gear and a clutch ring, and wherein the inner drive gear is configured to translate axially to shift the disconnect between the engaged state and the disengaged state.

7. The method of claim 6, wherein the inner drive gear is engaged to a plurality of splines on the axle, and wherein the clutch ring is engaged to a plurality of splines on the hub.

8. The method of claim 1, wherein the disconnect comprises a thrust bearing positioned to reduce wear between the hub and the disconnect.

9. The method of claim 1, further comprising installing a motor assembly into the disconnect.

10. The method of claim 9, wherein the motor assembly comprises snap-fit connectors.

11. The method of claim 1, wherein mounting the disconnect on the knuckle comprises aligning a perimeter of a vehicle-facing surface of the disconnect housing with a perimeter of the wheel-facing side of the knuckle.

12. An axial disconnect system for a vehicle wheel end, the system comprising:
a knuckle comprising a wheel-facing side and a vehicle-facing side
an axle, configured to rotate and transmit torque to and from a vehicle drivetrain;
a hub, configured to support vehicle wheel components; and
a disconnect, comprising a disengaged state permitting relative rotation between the axle and a hub and an engaged state preventing relative rotation between the axle and the hub, wherein the disconnect is mounted to the wheel-facing side of the knuckle.

13. The system of claim 12, wherein the disconnect is mounted to the knuckle and the hub is mounted to the disconnect using the same mounting points.

14. The system of claim 12, wherein the disconnect comprises an inner drive gear and a clutch ring, and wherein the inner drive gear is configured to translate axially to shift the disconnect between the engaged state and the disengaged state.

15. The system of claim 14, wherein the inner drive gear is engaged to a plurality of splines on the axle, and wherein the clutch ring is engaged to a plurality of splines on the hub.

16. The system of claim 12, wherein the knuckle comprises a cavity, wherein the cavity is sufficiently large to allow the axle to pass entirely through the knuckle.

17. The system of claim 12, wherein the hub is coupled to the disconnect using a retaining ring.

18. The system of claim 12, wherein the disconnect comprises an electric motor configured to drive a worm gear, wherein the worm gear rotates a cam gear to shift the disconnect between the engaged and the disengaged states.
